(19) United States
(12) Patent Application Publication
(10) Pub. No.: US 2006/0290263 A1
(43) Pub. Date: Dec. 28, 2006

(54) Image display device

(76) Inventors: Satoshi Ishikawa, Fukaya-shi (JP); Sachiko Hirahara, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/512,213

(22) Filed: Aug. 30, 2006

Related U.S. Application Data
(63) Continuation of application No. PCT/JP05/04209, filed on Mar. 10, 2005.

(30) Foreign Application Priority Data
Mar. 16, 2004 (JP) 2004-074442
Mar. 16, 2004 (JP) 2004-074785

(51) Int. Cl. H01J 63/04

(52) U.S. Cl. 313/495; 313/498; 313/292

(57) ABSTRACT

A spacer structure is provided between a first substrate having a phosphor screen formed thereon and a second substrate provided with a plurality of electron emission sources. Each spacer structure has a supporting substrate, which is opposed to the first and second substrates and has a plurality of electron beam passage apertures opposed individually to the electron emission sources, and a plurality of spacers set up on a surface of the supporting substrate. The supporting substrate is formed by joining together a plurality of divided substrates. Joint portions between the divided substrates extend astride the electron beam passage apertures of the supporting substrate.

### CROSS-REFERENCE TO RELATED APPLICATIONS

This is a Continuation Application of PCT Application No. PCT/JP2005/004209, filed Mar. 10, 2005, which was published under PCT Article 21(2) in Japanese.

This application is based upon and claims the benefit of priority from prior Japanese Patent Applications No. 2004-074442, filed Mar. 16, 2004; and No. 2004-074785, filed Mar. 16, 2004, the entire contents of both of which are incorporated herein by reference.

### BACKGROUND OF THE INVENTION

1. Field of the Invention

This invention relates to an image display device provided with substrates opposed to each other and a spacer structure located between the substrates.

2. Description of the Related Art

In recent years, various flat image display devices have been noticed as a next generation of lightweight, thin display devices to replace cathode-ray tubes (CRTs). For example, a surface-conduction electron emission device (SED) has been developed as a kind of field emission device (FED) that constitutes a flat display device.

As described in Jpn. Pat. Appln. KOKAI Publication No. 2002-082850, for example, an SED comprises a first substrate and a second substrate that are opposed to each other across a predetermined gap. These substrates have their respective peripheral portions joined together by a rectangular sidewall, thereby constituting a vacuum envelope. Three-color phosphor layers are formed on the inner surface of the first substrate. Arranged on the inner surface of the second substrate are a large number of electron emitting elements for use as electron emission sources that excite the phosphors. In order to support an atmospheric load that acts on the first substrate and the second substrate and maintain the gap between the substrates, a plurality of spacers are located between the two substrates. A supporting substrate is provided between the first substrate and the second substrate, and the plurality of spacers are set up on the supporting substrate. The supporting substrate is formed having a plurality of electron beam passage apertures through which electron beams emitted individually from the electron emitting elements pass.

In displaying an image on the SED described above, an anode voltage is applied to the phosphor layers, and the electron beams emitted from the electron emitting elements are accelerated by the anode voltage and collided with the phosphor layers. Thereupon, the phosphors glow and display the image. In order to obtain practical display characteristics, it is necessary to use phosphors similar to those of conventional cathode ray tubes and set the anode voltage to several kV or more, and preferably, to 5 kV or more.

For an SED constructed in this manner, it is an important problem to align the spacers and the electron beam passage apertures with the first substrate and the second substrate. For example, the electron beam passage apertures in the supporting substrate and the spacers must be provided lest they intercept electrons emitted from the electron emitting elements. In particular, the supporting substrate must be formed with high precision and aligned highly accurately with the first substrate and the second substrate lest the trajectories of electron beams from the electron emitting elements toward the phosphors be blocked by the supporting substrate. The larger and the more precise the display device, the more serious this problem is.

If the display device is made large-sized, a spacer structure that is composed of the spacers and the supporting substrate is expected to be also large-sized. According to existing manufacturing methods, however, it may possibly be difficult to manufacture a large-sized supporting substrate or to make the spacer structure large-sized. Otherwise, the manufacturing costs of members are supposed to be high. The larger the size of the supporting substrate, the lower the accuracy of position coordinates for the formation of the electron beam passage apertures is.

### BRIEF SUMMARY OF THE INVENTION

The present invention has been made in consideration of these circumstances, and its object is to provide an image display device capable of being increased in size and enhanced in precision.

In order to achieve the object, according to an aspect of the invention, there is provided an image display device comprising: a first substrate having a phosphor screen formed thereon; a second substrate located opposite the first substrate across a gap and provided with a plurality of electron emission sources which excite the phosphor screen; and a spacer structure which is provided between the first and second substrates and supports an atmospheric load acting on the first and second substrates, the spacer structure having a supporting substrate, which is opposed to the first and second substrates and has a plurality of electron beam passage apertures opposed individually to the electron emission sources, and a plurality of spacers set up on a surface of the supporting substrate, the supporting substrate being formed by joining together a plurality of divided substrates such that joint portions between the divided substrates extend astride the electron beam passage apertures of the supporting substrate.

According to another aspect of the invention, there is provided an image display device comprising: a first substrate having a phosphor screen formed thereon; a second substrate located opposite the first substrate across a gap and provided with a plurality of electron emission sources which excite the phosphor screen; and a spacer structure which is provided between the first and second substrates and supports an atmospheric load acting on the first and second substrates, the spacer structure having a plate-like supporting substrate, which is opposed to the first and second substrates and has a plurality of electron beam passage apertures opposed individually to the electron emission sources, and a plurality of spacers set up on a surface of the supporting substrate, the supporting substrate being formed by joining together a plurality of divided substrates such that a joint portion of each divided substrate is formed thinner than the other portions of the divided substrate, is lapped on the joint portion of another divided substrate in a plate thickness direction thereof as the joint portions are joined together, and has a position adjustment width such that the position of the divided substrate is adjustable in a surface direction thereof.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an SED according to a first embodiment of this invention;

FIG. 2 is a perspective view of the SED, broken away along line II-II of FIG. 1;

FIG. 3 is a sectional view of the SED taken along line III-III of FIG. 1;

FIG. 4 is a perspective view showing a second substrate and a spacer structure of the SED;

FIG. 5 is a perspective view enlargedly showing joint portions of a supporting substrate of the spacer structure;

FIG. 6 is an exploded perspective view showing the joint portions of the supporting substrate;

FIG. 7 is a sectional view of the joint portion taken along line VII-VII of FIG. 5;

FIG. 8 is a sectional view of a joint portion of a supporting substrate according to a modification;

FIG. 9 is a perspective view, partially in section, showing an SED according to a second embodiment of this invention;

FIG. 10 is a sectional view of the SED according to the second embodiment;

FIG. 11 is a perspective view showing a second substrate and a spacer structure of the SED according to the second embodiment;

FIG. 12 is a perspective view enlargedly showing joint portions of a supporting substrate of the spacer structure;

FIG. 13 is an exploded perspective view showing the joint portions of the supporting substrate;

FIG. 14 is a sectional view showing the joint portions of the supporting substrate; and

FIG. 15 is a sectional view showing an SED according to a third embodiment of this invention.

### DETAILED DESCRIPTION OF THE INVENTION

A first embodiment in which this invention is applied to an SED as a flat image display device will now be described in detail with reference to the drawings.

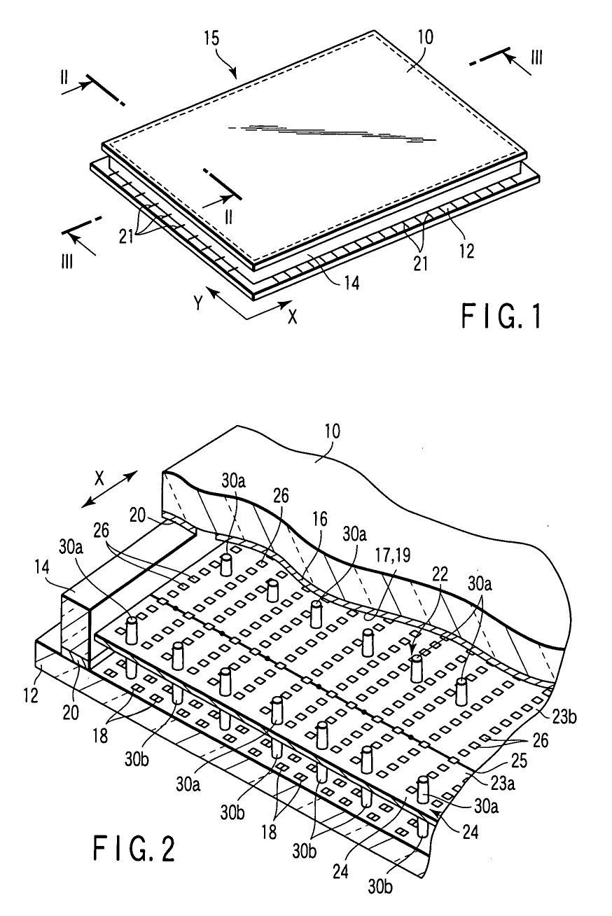

As shown in FIGS. 1 to 3, the SED comprises a first substrate 10 and a second substrate 12, which are formed of a rectangular glass plate each. These substrates are located opposite each other with a gap of about 1.0 to 2.0 mm between them. The first substrate 10 and the second substrate 12 have their respective peripheral edge portions joined together by a sidewall 14 of glass in the form of a rectangular frame, thereby forming a flat vacuum envelope 15 of which the inside is kept evacuated.

A phosphor screen 16 that functions as a phosphor screen is formed on the inner surface of the first substrate 10. The phosphor screen 16 is formed of phosphor layers R, G and B, which glow red, blue, and green, individually, and light shielding layers 11 arranged side by side. These phosphor layers are stripe-shaped, dot-shaped, or rectangular. A metal back 17 of aluminum or the like and a getter film 19 are successively formed on the phosphor screen 16.

Provided on the inner surface of the second substrate 12 are a large number of surface-conduction electron emitting elements 18, which individually emit electron beams as electron sources for exciting the phosphor layers R, G and B of the phosphor screen 16. These electron emitting elements 18 are arranged in a plurality of columns and a plurality of rows corresponding to individual pixels. Each electron emitting element 18 is formed of an electron emitting portion (not shown), a pair of element electrodes that apply voltage to the electron emitting portion, etc. A large number of wires 21 for supplying potential to the electron emitting elements 18 are provided in a matrix on the inner surface of the second substrate 12, and their respective end portions are led out of the vacuum envelope 15.

The sidewall 14 that functions as a joint member is sealed to the peripheral edge portion of the first substrate 10 and the peripheral edge portion of the second substrate 12 with a sealant 20 of, for example, low-melting-point glass or low-melting-point metal, whereby these substrates are joined together.

As shown in FIGS. 2 to 4, the SED comprises a spacer structure 22 that is located between the first substrate 10 and the second substrate 12. The spacer structure 22 is composed of a supporting substrate 24, formed of a rectangular metal plate located between the first substrate 10 and the second substrate 12, and a large number of columnar spacers set up integrally on the opposite surfaces of the supporting substrate. The spacer structure 22 is located covering the entire display region.

The supporting substrate 24 of the spacer structure 22 has a rectangular shape and is formed by joining together a plurality of, e.g., two, divided substrates, as mentioned later. The supporting substrate 24 has a first surface 24a opposed to the inner surface of the first substrate 10 and a second surface 24b opposed to the inner surface of the second substrate 12, and is located parallel to these substrates. A large number of electron beam passage apertures 26 are formed in the supporting substrate 24 by etching or the like.

The electron beam passage apertures 26 are arranged in a plurality of rows and a plurality of columns. If the extending directions of the long sides and short sides of the vacuum envelope 15 and the supporting substrate 24 are a first direction X and a second direction Y, respectively, the electron beam passage apertures 26 are arranged at first pitches in the first direction X with bridge portions between them, and are also arranged at second pitches larger than the first pitches in the second direction Y. The electron beam passage apertures 26 are arrayed opposite the electron emitting elements 18, individually, and are permeated by the electron beams emitted from the electron emitting elements.

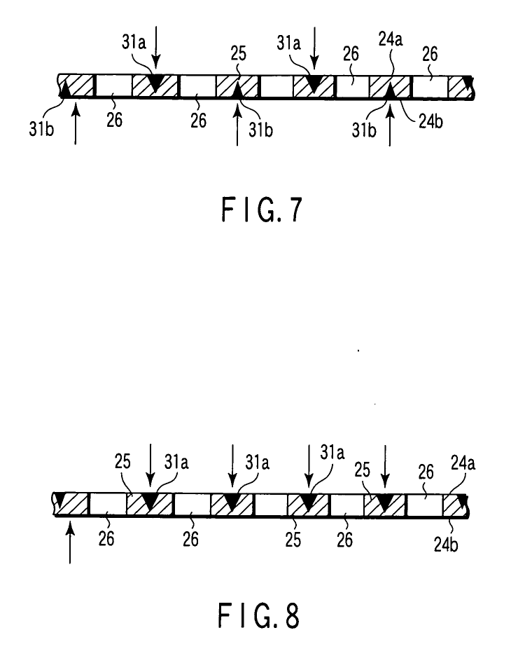

As shown in FIGS. 2 to 7, the supporting substrate 24 is a single plate that is formed by joining two divided substrates 23a and 23b individually having rectangular shapes. The divided substrates 23a and 23b are each formed of a plate of, for example, an iron-nickel-based metal with a thickness of 0.1 to 0.3 mm. One end face of each of the divided substrates 23a and 23b, e.g., a long-side end face that extends in the second direction Y, forms a joint portion 25. The divided substrates 23a and 23b are joined together with their respective joint portions 25 butted against each other. The joint portions 25 are situated in the central part of the supporting substrate 24 with respect to the first direction X and extend covering the overall length of the supporting substrate in the second direction Y. The joint portions 25 are situated overlapping the electron beam passage apertures 26 in one column arranged in the second direction Y of the supporting substrate 24 and extend astride each electron beam passage aperture.

The respective joint portions 25 of the divided substrates 23a and 23b are joined together by, for example, spot welding. The joint portions 25 are welded at at least one spot between each two adjacent electron beam passage apertures 26. In this case, a plurality of spots of the joint portions 25 of the divided substrates 23a and 23b are welded from one surface side of the supporting substrate 24, and another plurality of spots are welded from the other surface side of the supporting substrate. Weld zones 31a on the one surface side of the supporting substrate and weld zones 31b on the other surface side of the supporting substrate are arranged alternately in the extending direction of the joint portions 25.

The joint portions 25 may be welded by arc welding, laser welding, etc., as well as by spot welding. The joint portions 25 may be joined together by brazing, adhesive bonding, thermocompression bonding, etc., as well as by welding.

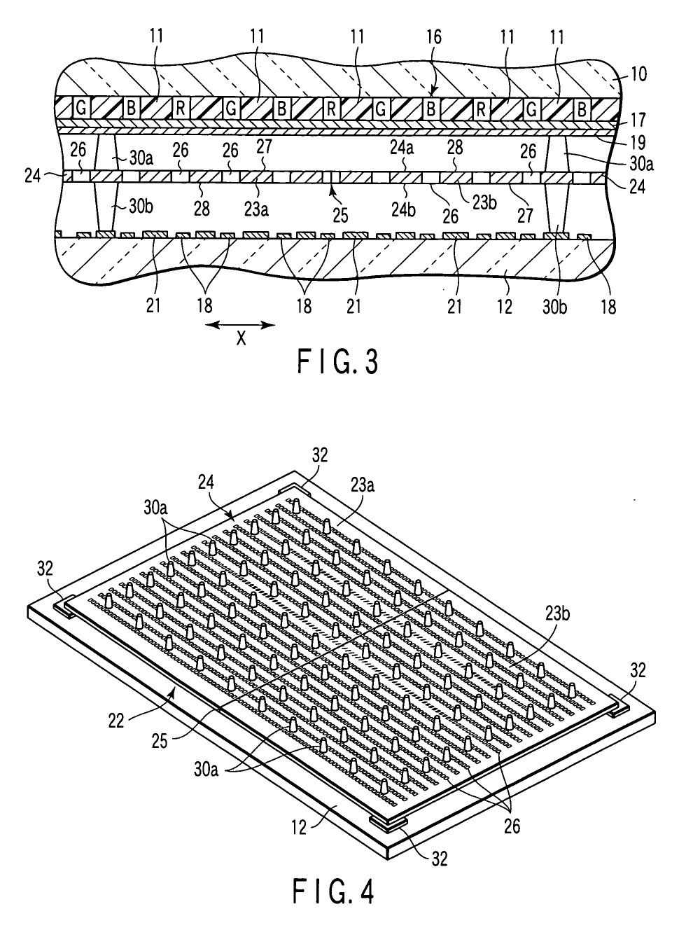

As shown in FIG. 3, an oxide film of elements that constitute the metal plate, e.g., an oxide film of Fe₃O₄ or NiFe₂O₄, is formed on the surfaces of the supporting substrate 24. The surfaces 24a and 24b of the supporting substrate 24 and the respective wall surfaces defining the electron beam passage apertures 26 are covered by a dielectric layer 27 that consists mainly of glass or ceramic. Further, the surfaces 24a and 24b and the peripheral edge portion of the supporting substrate 24 and the respective wall surfaces of the electron beam passage apertures 26 are covered by a coat layer 28 as a high-resistance film that has a preventive effect against secondary electron generation. The coat layer 28 is formed overlapping the dielectric layer 27.

The coat layer 28 contains a material such as chromium oxide, copper oxide, or ITO whose secondary electron emission coefficient is as low as 0.4 to 2.0. There are found various such materials with low secondary electron emission coefficients, many of which exist in good conductors that generally have free electrons. In the SED, as mentioned later, however, a relatively high voltage of about 10 kV is applied between the first substrate 10 and the second substrate 12, so that a material with a relatively high resistance, such as a dielectric material or semiconductor, is selected as the coat layer. Chromium oxide is a material that has a relatively high volume resistance of, for example, about 10⁵ Ωcm and a low secondary electron emission coefficient. Preferably, the supporting substrate 24 that constitutes the spacer structure 22 has a surface resistance of 10⁷ Ωcm or more. In the present embodiment, therefore, the coat layer 28 is formed of a composite material that is prepared by mixing a glass paste and chromium oxide powder. Thus, an electric discharge restraining effect can be obtained by macroscopically increasing the surface resistance value of the supporting substrate 24.

As shown in FIGS. 2 to 4, a plurality of first spacers 30a are set up integrally on the first surface 24a of the supporting substrate 24 and individually situated between the electron beam passage apertures 26 that are arranged in the second direction Y. The respective distal ends of the first spacers 30a abut against the inner surface of the first substrate 10 interposing the getter film 19, the metal back 17, and the light shielding layers 11 of the phosphor screen 16 between them.

A plurality of second spacers 30b are set up integrally on the second surface 24b of the supporting substrate 24 and are individually situated between the electron beam passage apertures 26 that are arranged in the second direction Y. The respective distal ends of the second spacers 30b abut against the inner surface of the second substrate 12. In this case, the respective distal ends of the second spacers 30b are situated individually on the wires 21 that are provided on the inner surface of the second substrate 12. The first and second spacers 30a and 30b are situated in alignment with one another and are formed integrally with the supporting substrate 24 in a manner such that the supporting substrate 24 is held between them from both sides.

Each of the first and second spacers 30a and 30b is tapered so that its diameter is reduced from the side of the supporting substrate 24 toward its extended end. For example, each of the first and second spacers 30a and 30b has a substantially elliptical cross-sectional shape.

The spacer structure 22 constructed in this manner is located in a manner such that the long sides of the supporting substrate 24 extend parallel to the first direction X of the second substrate 12. Each corner portion of the supporting substrate 24 is fixed to a supporting member 32 that is set up on the inner surface of the second substrate 12. The first and second spacers 30a and 30b of each spacer structure 22 abut against the respective inner surfaces of the first substrate 10 and the second substrate 12, thereby bearing the atmospheric load that acts on these substrates and keeping the space between the substrates at a predetermined value.

The SED comprises voltage supply portions (not shown) that apply voltages to the supporting substrate 24 and the metal back 17 of the first substrate 10. The voltage supply portions are connected individually to the supporting substrate 24 and the metal back 17, and apply voltages of, e.g., 12 and 10 kV to the supporting substrate 24 and the metal back 17, respectively. In displaying an image on the SED, an anode voltage is applied to the phosphor screen 16 and the metal back 17, and electron beams emitted from the electron emitting elements 18 are accelerated by the anode voltage and collided with the phosphor screen 16. Thereupon, the phosphor layers of the phosphor screen 16 are excited to luminescence and display the image.

The following is a description of a manufacturing method for the SED constructed in this manner. A manufacturing method for the spacer structure 22 will be described first.

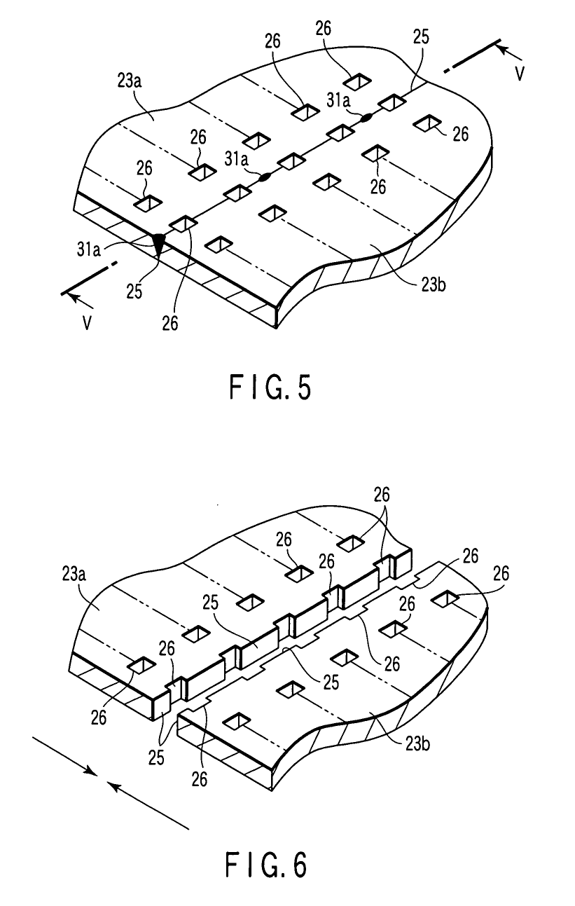

The two divided substrates 23a and 23b formed having a predetermined size each are prepared. Metal plates with a plate thickness of 0.12 mm that contain 45 to 55% by weight of nickel, iron for the remainder, and unavoidable impurities are used for the divided substrates. After these metal plates are degreased, washed, and dried, the electron beam passage apertures 26 are formed by etching. Subsequently, after the respective joint portions 25 of the metal plates, that is, the end faces of the metal plates, are butted against each other, as shown in FIGS. 5 and 6, the two metal plates are aligned in the second direction Y.

After the position alignment is finished, the respective joint portions 25 of the two metal plates are joined together by welding, whereupon one metal plate that is rectangular as a whole is formed. Subsequently, after this metal plate is entirely oxidized, the dielectric layer 27 is formed on the surface of the metal plate including the respective inner surfaces of the electron beam passage apertures 26. Further, a coating solution that is prepared by mixing a glass paste with about 30% by weight of chromium oxide (Cr₂O_{3-α}: α=−0.5 to 0.5) is spread on the dielectric layer 27 by spraying, dried, and then fired, whereupon the coat layer 28 is formed. Thus, the supporting substrate 24 with a predetermined size is obtained.

The coat layer 28 is not limited to a coating film but may be a layer that is obtained by forming a thin film of chromium oxide on the surface of the supporting substrate by vacuum vapor deposition, sputtering, ion plating, or the sol-gel method.

An upper die 36a and a lower die 36b, each in the form of a rectangular plate having substantially the same size as the supporting substrate, are prepared. The upper die and the lower die for use as molding dies are flat plates formed of a transparent material that transmits ultraviolet rays, e.g., clear silicone or clear polyethylene terephthalate. The upper die has a flat contact surface in contact with the supporting substrate 24 and a large number of bottomed spacer forming holes for molding the first spacers 30a. The spacer forming holes individually open in the contact surface of the upper die and are arranged at predetermined spaces. Likewise, the lower die has a flat contact surface and a large number of bottomed spacer forming holes for molding the second spacers 30b. The spacer forming holes individually open in the contact surface of the lower die and are arranged at predetermined spaces. The upper die and the lower die may alternatively be formed by combining a plurality of divided dies.

Subsequently, the spacer forming holes of the upper die and the spacer forming holes of the lower die are loaded with a spacer forming material. A glass paste that contains at least an ultraviolet-curing binder (organic component) and a glass filler is used as the spacer forming material. The specific gravity and viscosity of the glass paste are selected as required.

The upper die is positioned so that the spacer forming holes filled with the spacer forming material individually face regions between the adjacent electron beam passage apertures 26, and the contact surface is brought into close contact with the first surface 24a of the supporting substrate 24. Likewise, the lower die is positioned so that the spacer forming holes individually face regions between the adjacent electron beam passage apertures 26, and the contact surface is brought into close contact with the second surface 24b of the supporting substrate 24. An adhesive may be previously applied to spacer setup positions on the supporting substrate 24 by means of a dispenser or by printing. Thus, an assembly is formed having the supporting substrate 24, upper die, and lower die. In the assembly, the spacer forming holes of the upper die and the spacer forming holes of the lower die are arranged opposite one another with the supporting substrate 24 between them.

Then, ultraviolet (UV) rays are applied to the upper die and the lower die from ultraviolet lamps that are located outside the upper die and the lower die. The upper die and the lower die are individually formed of an ultraviolet transmitting material. Therefore, the ultraviolet rays radiated from the ultraviolet lamps are transmitted through the upper die and the lower die and applied to the loaded spacer forming material. Thus, the spacer forming material is ultraviolet-cured with the assembly kept in a close-contact state.

Subsequently, the upper die and the lower die are released from the supporting substrate 24 with the cured spacer forming material left on the supporting substrate 24. Thereafter, the supporting substrate 24 with the spacer forming material thereon is heat-treated in a heating furnace so that the binder is evaporated from the spacer forming material, and the spacer forming material is then regularly fired at about 500 to 550° C. for 30 minutes to 1 hour. Thus, the spacer structure 22 is obtained having the first and second spacers 30a and 30b built-in on the supporting substrate 24.

In the manufacture of the SED, on the other hand, the first substrate 10, which is provided with the phosphor screen 16 and the metal back 17, and the second substrate 12, which is provided with the electron emitting elements 18 and the wires 21 and joined with the sidewall 14, are prepared in advance. Subsequently, the spacer structure 22 obtained in the aforesaid manner is positioned on the second substrate 12 and fixed to the supporting member 32. In this state, the first substrate 10, second substrate 12, and spacer structure 22 are located in a vacuum chamber, the vacuum chamber is evacuated, and the first substrate is then joined to the second substrate with the sidewall 14 between them. Thus, the SED having the spacer structure 22 is manufactured.

According to the SED constructed in this manner, the supporting substrate 24 of the spacer structure 22 is formed by joining together a plurality of divided substrates. Therefore, each divided substrate can be miniaturized, so that the accuracy of machining for the divided substrates, such as etching or laser machining, can be improved. Thus, the supporting substrate can be obtained having high dimensional accuracy. Each divided substrate can be manufactured at low cost by an existing manufacturing method and an existing manufacturing apparatus. If the pixel pitches of the SED are lessened for higher precision or if the SED is made large-sized, therefore, the spacer structure can be aligned highly accurately with the electron emitting elements and the like. Thus, a large-sized, high-precision SED can be obtained.

The joint portions between the divided substrates are situated overlapping a column of electron beam passage apertures of the supporting substrate and extend astride or across the electron beam passage apertures. The joint portions are welded to each other between the adjacent electron beam passage apertures. Thus, welding spots of the joint portions can be reduced in number, and heat from the supporting substrate during welding operation can be dispersed to prevent thermal deformation of the supporting substrate.

As the precision of the SED is enhanced, the pitches of the electron beam passage apertures are reduced. In joining a plurality of divided substrates that are separated by the regions between the electron beam passage apertures, therefore, it is hard to secure spaces for the formation of the joint portions. According to the present embodiment, however, the joint portions are provided overlapping a column of electron beam passage apertures and extend astride the electron beam passage apertures. Even if the array pitches of the electron beam passage apertures are reduced, therefore, the formation spaces for the joint portions can be secured. Thus, the precision can be further enhanced.

In the joint portions between the divided substrates, according to the present embodiment, a plurality of spots are welded from one surface side of the supporting substrate, and another plurality of spots are welded from the other surface side of the supporting substrate. Accordingly, thermal stresses that are produced in the supporting substrate during welding operation can be caused to cancel each other from both surface sides of the supporting substrate, so that the supporting substrate can be prevented from warping or undulating at the joint portions.

In the SED described above, the supporting substrate of the spacer structure is formed by joining together the two divided substrates. However, the divided substrates are not limited to two in number, but the supporting substrate may be joining together three or more divided substrates. Further, the position where the divided substrates are joined is not limited to the center of the supporting substrate 24 with respect to the first direction X but may be changed as required. The plurality of divided substrates need not be formed in the same size but may be formed in different sizes.

In the embodiment described above, the joint portions 25 between the divided substrates are alternately welded from the opposite surface sides of the supporting substrate. Alternatively, however, they may be welded at every spot but two or three or at random from the different surface sides. As shown in FIG. 8, all the weld zones at the joint portions 25 may be welded from one surface side of the supporting substrate 24. In this case, a welding process can be simplified. Thus, welding from one surface side requires only one cycle of welding operation, which is fewer than the cycles of welding operation that are required by welding from both surface sides. Ideally, one-side welding is preferred in consideration of driven conditions. If characteristics cannot be fulfilled, however, both-sides welding is performed despite an increase in man-hours.

The following is a description of a second embodiment of this invention. In the first embodiment described above, the joint portion 25 of each divided substrate is formed of a side edge of the substrate, and the respective joint portions of the plurality of divided substrates are joined together by butting. According to the second embodiment, however, the respective joint portions are joined together by lapping in the thickness direction of a supporting substrate 24.

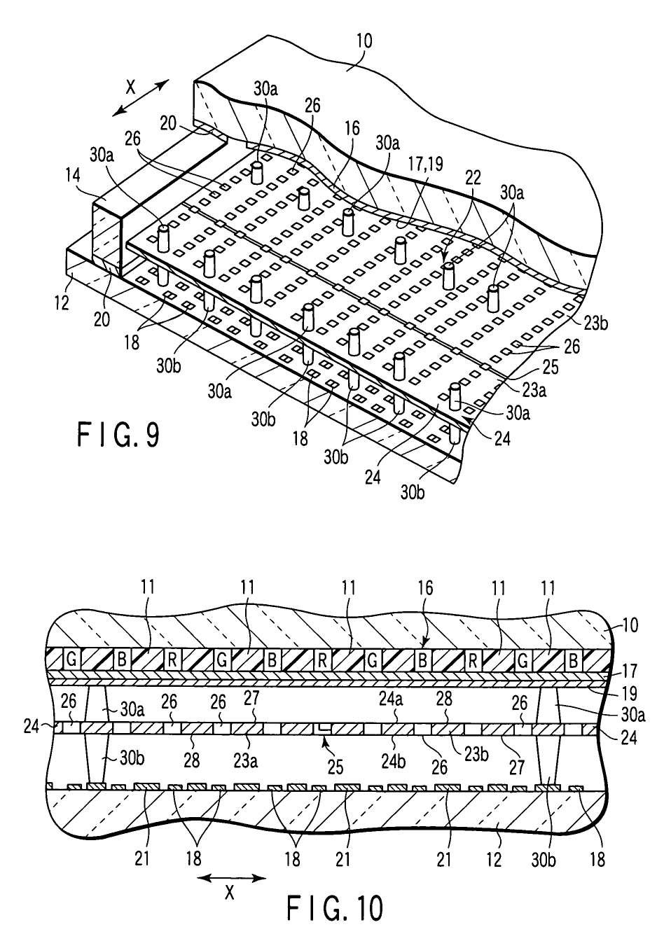

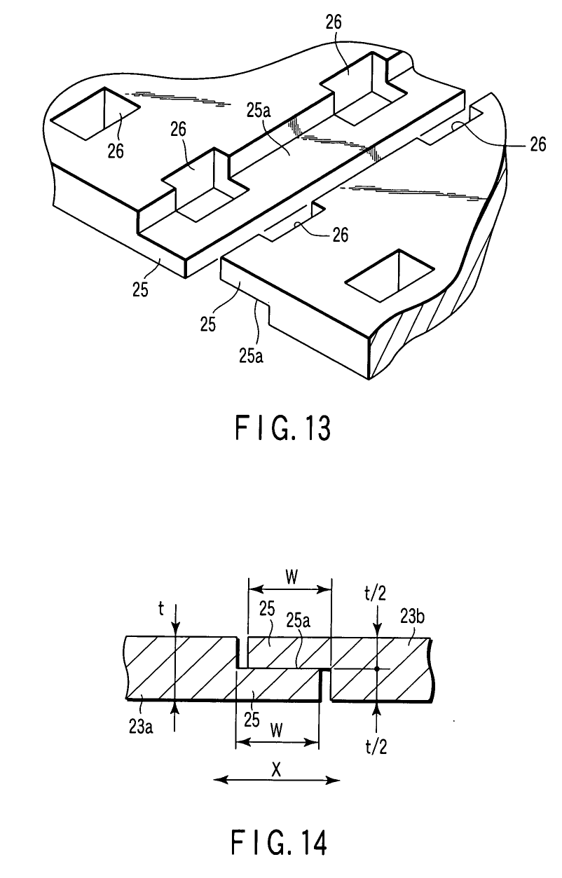

As shown in FIGS. 9 to 14, the supporting substrate 24 is a single plate that is formed by joining two divided substrates 23a and 23b individually having rectangular shapes. The divided substrates 23a and 23b are each formed of a plate of, for example, an iron-nickel-based metal with a thickness t of 0.1 to 0.3 mm. A joint portion 25 is formed covering the overall length of one side of each of the divided substrates 23a and 23b, e.g., a long side that extends in the second direction Y. The joint portion 25 is formed with a thickness t/2, which is equal to about half of the thickness t of each divided substrate and has a joint surface 25a that extends substantially parallel to the surface of each divided substrate. The joint surface 25a is situated with a difference of t/2 in level from the surface of the each divided substrate. Further, the joint surface 25a has an adjustment width W in the first direction X or a direction perpendicular to its long sides. The joint portion 25 is formed by half-etching each of the divided substrates 23a and 23b, for example.

The respective joint portions 25 of the divided substrates 23a and 23b are superposed in the plate thickness direction and joined together with their respective joint surfaces 25a in contact with each other. In this case, the joint portions 25 of the divided substrates 23a and 23b are joined together in a manner such that those regions in which the joint portions 25 are superposed in the plate thickness direction are continuously welded from one surface side of each divided substrate. A weld zone 31 extends substantially covering the overall length of the joint portions 25 in the second direction Y. Arc welding, spot welding, laser welding, etc. may be used for the welding work. The joint portions 25 may be joined together by brazing, adhesive bonding, thermocompression bonding, etc., as well as by welding. Since the plate thickness of each joint portion 25 is adjusted to t/2, the total thickness of the joined joint portions is substantially equal to the plate thickness t of the supporting substrate 24.

Alternatively, the joint portions 25 may be welded in the same manner as in the foregoing first embodiment. Specifically, a plurality of spots of the joint portions may be partially welded from both surface sides or one surface side of the supporting substrate.

The joint portions 25 are situated in the central part of the supporting substrate 24 with respect to the first direction X and extend covering the overall length in the second direction. In the second embodiment, the joint portions 25 are situated overlapping a column of electron beam passage apertures 26 extending in the second direction Y of the supporting substrate 24 and extend astride each electron beam passage aperture. Alternatively, the joint portions 25 may be formed in positions off the electron beam passage apertures 26 without bestriding the electron beam passage apertures.

In the second embodiment, other configurations of an SED are the same as those of the foregoing first embodiment, so that like reference numerals are used to designate like portions, and a detailed description thereof is omitted.

The following is a description of a manufacturing method for the SED constructed in this manner. A manufacturing method for a spacer structure 22 will be described first.

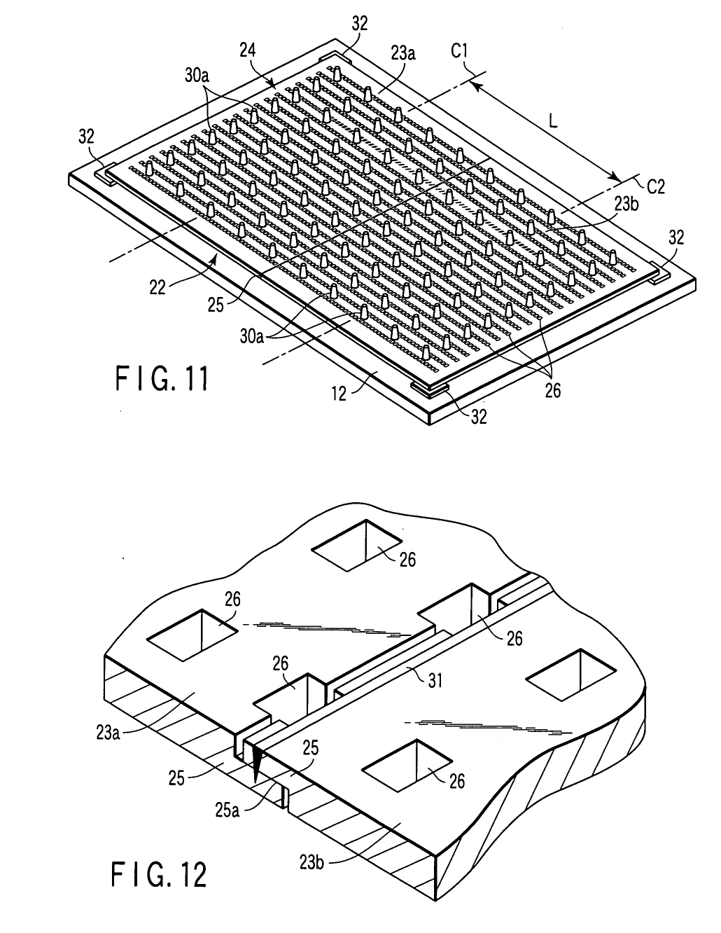

The two divided substrates 23a and 23b formed having a predetermined size each are prepared. Metal plates with a plate thickness of 0.12 mm that contain 45 to 55% by weight of nickel, iron for the remainder, and unavoidable impurities are used for the divided substrates. After these metal plates are degreased, washed, and dried, the electron beam passage apertures 26 are formed by etching, and the joint portion 25 is formed on one side edge portion by half-etching. Subsequently, after the two metal plates are aligned along the second direction Y with the respective joint portions 25 of the metal plates superposed, they are aligned along the first direction X, as shown in FIGS. 12 to 14. In doing this, the two metal plates are moved and aligned with the respective joint portions 25 of the joint portions 25 in contact with each other. With respect to the first direction X, as shown in FIG. 11, the metal plates are aligned so that a distance L between center lines C1 and C2 that pass through the respective centers of the individual metal plates in the first direction X has a predetermined value. Since the joint surface 25a of each joint portion 25 has the appropriate adjustment width W in the first direction X, the two metal plates can be aligned so that the distance L is a desired dimension.

After the position alignment is finished, the respective joint portions 25 of the two metal plates are joined together by welding, whereupon one metal plate that is rectangular as a whole is formed. Subsequently, after this metal plate is entirely oxidized, a dielectric layer 27 is formed on the surface of the metal plate including the respective inner surfaces of the electron beam passage apertures 26. Further, a coating solution that is prepared by mixing a glass paste with about 30% by weight of chromium oxide (Cr₂O_{3-α}: α=−0.5 to 0.5) is spread on the dielectric layer 27 by spraying, dried, and then fired, whereupon a coat layer 28 is formed. Thus, the supporting substrate 24 with a predetermined size is obtained.

The coat layer 28 is not limited to a coating film but may be a layer that is obtained by forming a thin film of chromium oxide on the surface of the supporting substrate by vacuum vapor deposition, sputtering, ion plating, or the sol-gel method.

Subsequently, a first spacer 30a and a second spacer 30b are formed on the supporting substrate 24 by the same method of the foregoing first embodiment. Thus, the spacer structure 22 is obtained. Thereafter, the spacer structure 22 is positioned on a second substrate 12 and fixed to a supporting member 32. In this state, a first substrate 10, the second substrate 12, and the spacer structure 22 are located in a vacuum chamber, the vacuum chamber is evacuated, and the first substrate is then joined to the second substrate with a sidewall 14 between them. Thus, the SED having the spacer structure 22 is manufactured.

According to the SED constructed in this manner, the supporting substrate 24 of the spacer structure 22 is formed by joining together a plurality of divided substrates. Therefore, each divided substrate can be miniaturized, so that the accuracy of machining for the divided substrates, such as etching or laser machining, can be improved. Further, each divided substrate can be manufactured at low cost by an existing manufacturing method and an existing manufacturing apparatus. Since the joint portion of each divided substrate has the adjustment width for position adjustment along the surface direction of the divided substrate, moreover, a plurality of divided substrates can be accurately aligned to ensure the supporting substrate with high dimensional accuracy. If the pixel pitches of the SED are lessened for higher precision or if the SED is made large-sized, therefore, the spacer structure can be aligned highly accurately with the electron emitting elements and the like. Thus, a large-sized, high-precision SED can be obtained.

In the SED described above, the supporting substrate of the spacer structure is formed by joining together the two divided substrates. However, the divided substrates are not limited to two in number, but the supporting substrate may be joining together three or more divided substrates. Further, the position where the divided substrates are joined is not limited to the center of the supporting substrate with respect to the first direction but may be changed as required. The plurality of divided substrates need not be formed in the same size but may be formed in different sizes.

Although the spacer structure according to each of the foregoing first and second embodiments integrally comprises the first and second spacers and the supporting substrate, the second spacers 30b may alternatively be formed on the second substrate 12. Further, the spacer structure may be provided with only a supporting substrate and second spacers such that the supporting substrate is in contact with the first substrate.

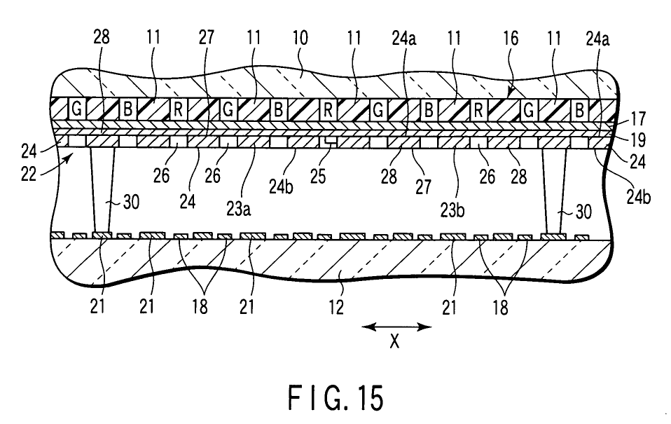

According to an SED according to a third embodiment of this invention, as shown in FIG. 15, a spacer structure 22 has a supporting substrate 24, formed of a rectangular metal plate, and a large number of columnar spacers 30 set up integrally on only one surface of the supporting substrate. The supporting substrate 24 is formed by joining together a plurality of, e.g., two, divided substrates 23a and 23b. The divided substrates 23a and 23b individually have joint portions 25 that are similar to the ones according to the foregoing embodiments. The joint portions 25 are situated overlapping a column of electron beam passage apertures 26 and extend astride the electron beam passage apertures.

The supporting substrate 24 has a first surface 24a opposed to the inner surface of a first substrate 10 and a second surface 24b opposed to the inner surface of a second substrate 12, and is located parallel to these substrates. A large number of electron beam passage apertures 26 are formed in the supporting substrate 24 by etching or the like. The electron beam passage apertures 26 are arrayed opposite electron emitting elements 18, individually, and are permeated by electron beams emitted from the electron emitting elements.

The first and second surfaces 24a and 24b of the supporting substrate 24 and the respective inner wall surfaces of the electron beam passage apertures 26 are covered by a dielectric layer 27 that consists mainly of glass or ceramic, and moreover, a coat layer 28 is formed overlapping the dielectric layer. The supporting substrate 24 is provided in a manner such that its first surface 24a is in surface contact with the inner surface of the first substrate 10 with a getter film 19, a metal back 17, and a phosphor screen 16 between them. The electron beam passage apertures 26 in the supporting substrate 24 individually face phosphor layers R, G and B of the phosphor screen 16. Thus, the electron emitting elements 18 face their corresponding phosphor layers through the electron beam passage apertures 26.

A plurality of spacers 30 are set up integrally on the second surface 24b of the supporting substrate 24 and are situated individually between the electron beam passage apertures 26. Respective extended ends of the spacers 30 abut against the inner surface of the second substrate 12 or, in this case, wires 21 that are provided on the inner surface of the second substrate 12. Each of the spacers 30 is tapered so that its diameter is reduced from the side of the supporting substrate 24 toward its extended end and is formed having a substantially elliptical cross-sectional shape.

In the spacer structure 22 constructed in this manner, the supporting substrate 24 is in surface contact with the first substrate 10, and the extended ends of the spacers 30 abut against the inner surface of the second substrate 12, thereby bearing the atmospheric load that acts on these substrates and keeping the space between the substrates at a predetermined value.

In the third embodiment, other configurations are the same as those of the foregoing second embodiment, so that like reference numerals are used to designate like portions, and a detailed description thereof is omitted. The SED according to the third embodiment and its spacer structure can be manufactured by a manufacturing method identical to the manufacturing method according to the foregoing embodiments. The same function and effect of the foregoing second embodiment can be also obtained with the present embodiment.

The present invention is not limited directly to the embodiments described above, and its components may be embodied in modified forms without departing from the spirit of the invention. Further, various inventions may be made by suitably combining a plurality of components described in connection with the foregoing embodiments. For example, some of the components according to the embodiments may be omitted. Furthermore, components according to different embodiments may be combined as required.

In the methods according to the foregoing embodiments, the spacers are formed on the single supporting substrate after the supporting substrate is formed by joining together the divided substrates. Alternatively, however, the divided substrates may be joined together after a plurality of spacer structures are formed by forming the spacers on the divided substrates.

The diameter and height of the spacers and the dimensions, materials, etc., of the other components are not limited to the foregoing embodiments, but may be suitably selected as required. This invention is not limited to image display devices that use surface-conduction electron emitting elements as electron sources, but may be also applied to image display devices that use other electron sources, such as the field-emission type, carbon nanotubes, etc.

What is claimed is:

1. An image display device comprising:
a first substrate having a phosphor screen formed thereon;
a second substrate located opposite the first substrate across a gap and provided with a plurality of electron emission sources which excite the phosphor screen; and
a spacer structure which is provided between the first and second substrates and supports an atmospheric load acting on the first and second substrates,
the spacer structure having a supporting substrate, which is opposed to the first and second substrates and has a plurality of electron beam passage apertures opposed individually to the electron emission sources, and a plurality of spacers set up on a surface of the supporting substrate,
the supporting substrate being formed by joining together a plurality of divided substrates such that joint portions between the divided substrates extend astride the electron beam passage apertures of the supporting substrate.

2. The image display device according to claim 1, wherein the electron beam passage apertures of the supporting substrate are arranged in a plurality of columns and a plurality of rows, and the joint portions between the divided substrates extend overlapping the electron beam passage apertures in one column.

3. The image display device according to claim 1, wherein the joint portions of the divided substrates are welded in regions between the adjacent electron beam passage apertures.

4. The image display device according to claim 3, wherein the joint portions of the divided substrates are welded from one surface side of the supporting substrate.

5. The image display device according to claim 3, wherein a plurality of spots of the joint portions of the divided substrates are welded from one surface side of the supporting substrate, and another plurality of spots are welded from the other surface side of the supporting substrate.

6. The image display device according to claim 5, wherein the joint portions of the divided substrates include weld zones in which the joint portions are welded from one surface side of the supporting substrate and weld zones in which the joint portions are welded from the other surface side of the supporting substrate, the weld zones being arranged alternately.

7. The image display device according to claim 1, wherein the joint portion of each of the divided substrates is formed thinner than the other portions of the divided substrate and is overlapped on the joint portion of another divided substrate in a plate thickness direction thereof as the joint portions are joined together.

8. The image display device according to claim 7, wherein each divided substrate is formed in the shape of a rectangle, and the joint portion is formed along at least one side of the divided substrate and has a position adjustment width such that the position of the divided substrate is adjustable in a direction perpendicular to the one side.

9. The image display device according to claim 1, wherein the supporting substrate has a first surface opposed to the first substrate and a second surface opposed to the second substrate, and the spacers include a plurality of first spacers set up on the first surface and a plurality of second spacers set upon the second surface.

10. The image display device according to claim 1, wherein the supporting substrate has a first surface in contact with the first substrate and a second surface opposed to the second substrate across a gap, and the spacers individually are set up on the second surface and has distal end portions which abut against the second substrate.

11. The image display device according to claim 1, wherein the spacers are columnar spacers.

12. An image display device comprising:
a first substrate having a phosphor screen formed thereon;
a second substrate located opposite the first substrate across a gap and provided with a plurality of electron emission sources which excite the phosphor screen; and
a spacer structure which is provided between the first and second substrates and supports an atmospheric load acting on the first and second substrates,
the spacer structure having a plate-like supporting substrate, which is opposed to the first and second substrates and has a plurality of electron beam passage apertures opposed individually to the electron emission sources, and a plurality of spacers set up on a surface of the supporting substrate,
the supporting substrate being formed by joining together a plurality of divided substrates such that a joint portion of each divided substrate is formed thinner than the other portions of the divided substrate, is lapped on the joint portion of another divided substrate in a plate thickness direction thereof as the joint portions are joined together, and has a position adjustment width such that the position of the divided substrate is adjustable in a surface direction thereof.

13. The image display device according to claim 12, wherein the thickness of the joint portion of each of the divided substrates is substantially half the plate thickness of the divided substrate.

14. The image display device according to claim 12, wherein the respective joint portions of the divided substrates are welded together in regions where the joint portions are superposed in the plate thickness direction.

15. The image display device according to claim 12, wherein each of the divided substrates is formed in the shape of a rectangle, and the joint portion is formed along at least one side of the divided substrate and has a position adjustment width in a direction perpendicular to the one side.

16. The image display device according to claim 12, wherein the supporting substrate has a first surface opposed to the first substrate and a second surface opposed to the second substrate, and the spacers include a plurality of first spacers set up on the first surface and a plurality of second spacers set upon the second surface.

17. The image display device according to claim 12, wherein the supporting substrate has a first surface in contact with the first substrate and a second surface opposed to the second substrate across a gap, and the spacers individually are set up on the second surface and has distal end portions which abut against the second substrate.

18. The image display device according to claim 12, wherein the spacers are columnar spacers.
